(19) United States
(12) Patent Application Publication
(10) Pub. No.: US 2013/0325924 A1
(43) Pub. Date: Dec. 5, 2013

(54) METHOD AND SYSTEM FOR SERVER-ASSISTED REMOTE PROBING AND DATA COLLECTION IN A CLOUD COMPUTING ENVIRONMENT

(71) Applicant: Mehran Moshfeghi, Rancho Palos Verdes, CA (US)

(72) Inventor: Mehran Moshfeghi, Rancho Palos Verdes, CA (US)

(21) Appl. No.: 13/488,793

(22) Filed: Jun. 5, 2012

(51) Int. Cl. G06F 15/16

(52) U.S. Cl. 709/203

(57) ABSTRACT

A client device receives probing information from an application server on a computing cloud comprising cloud services. The probing information comprises available resources for resource sharing. The client device manages associated sensors based on the received probing information and data traffic (category/QoS) handled by the associated sensors. Sensor data collected by sensors managed by client devices in an associated user group is utilized by the application server to generate the probing information. The locally collected sensor data is processed and aggregated over the user group by the application server to identify possible causes and/or possible solutions, which are communicated as probing information to the client device together with geographical locations and corresponding environmental conditions. Sensors in the user group are managed based on corresponding geographical locations for specific sensor behavior. Data traffic in the user group are managed based on corresponding QoS requirements and secured utilizing RSA encryption.

### CROSS-REFERENCE TO RELATED APPLICATIONS/INCORPORATION BY REFERENCE

Not applicable.

### FIELD OF THE INVENTION

Certain embodiments of the invention relate to communication systems. More specifically, certain embodiments of the invention relate to a method and system for server-assisted remote probing and data collection in a cloud computing environment.

### BACKGROUND OF THE INVENTION

With the continuous growth of on-line businesses, social networks, and other on-line services and applications, a user may want a larger number of places or locations from which to access the Internet in a manner that is flexible and/or suits the user's lifestyle. Most users currently connect to the Internet using a web browser running on a personal computer.

Cloud computing emerges as a new computing paradigm which aims to provide reliable, customized and guaranteed computing dynamic environments for end-users. Cloud computing is a new business model in which core computing and software capabilities are outsourced on demand to a shared third-party infrastructure. Cloud computing comprises three major cloud services: Software as a service (SaaS), data storage, and server platform. These services are typically offered in a subscription model with various means of pricing. Subscribers may access these cloud services available in the computing cloud without knowing how these resources are managed and where they are located.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for server-assisted remote probing and data collection in a cloud computing environment, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram that illustrates an exemplary remote probing and data collection in a cloud computing environment, in accordance with an embodiment of the invention.

FIG. 2 is a block diagram that illustrates an exemplary sensor application device that is operable to acquire sensor data in a cloud computing environment, in accordance with an embodiment of the invention.

FIG. 3 is a block diagram that illustrates an exemplary client device that is operable to remotely configure and calibrate sensors with the assistance of a cloud server platform, in accordance with an embodiment of the invention.

FIG. 4 is a diagram illustrating an exemplary cloud server platform that is operable to provide assistance for remote probing and data collection, in accordance with an embodiment of the invention.

FIG. 5 is a flow diagram that illustrates exemplary steps performed by a cloud application service for resource sharing, in accordance with an embodiment of the invention.

FIG. 6 is a flow diagram that illustrates exemplary steps for remote patient monitoring in a cloud computing environment, in accordance with an embodiment of the invention.

FIG. 7 is a flow diagram that illustrates exemplary steps for managing remote test instruments in a cloud computing environment, in accordance with an embodiment of the invention.

### DETAILED DESCRIPTION OF THE INVENTION

Certain embodiments of the invention may be found in a method and system for server-assisted remote probing and data collection in a cloud computing environment. In various embodiments of the invention, a computing cloud environment may comprise various cloud services such as such as a data storage service and an application server service. A client device may receive probing information from the application server that provides the application server service. The probing information may be generated by the application server based on sensor data collected from various local data collection sites. The client device may manage associated sensors based on the received probing information and based on data traffic that may be handled by the associated sensor. For example, the client device may manage associated sensors based on the received probing information and based on a category and/or QoS of data traffic that may be handled by the associated sensor. The sensor data may be captured by sensors managed by the client device and sensors managed by other highly correlated client devices. In an exemplary embodiment of the invention, the sensors may be deployed in or associated with various sensor applications such as, for example, medical testing equipment, semiconductor equipment, and/or electrical/electronic measuring instruments. The client device and the other highly correlated client devices may form a user group of the application server. The probing information may comprise available resources, which may be shared among the client devices in the user group. The data that is collected from the client devices in the user group may be processed and aggregated by the application server. In one exemplary embodiment of the invention, a portion of the sensors may be utilized or deployed in medical testing equipment and/or electrical/electronic measuring instruments. In this regard, the collected data may comprise patient data. The application server may perform multiple diagnostics and analysis of trends for the client devices in the user group utilizing the aggregated data and other information such as types of medical tests, types of patient data, and/or geographical locations and environmental conditions where the medical tests are performed. Possible causes and/or possible solutions for certain identified conditions may be determined based on the diagnostics and analysis of the trends. The possible causes and/or possible solutions together with the corresponding other information may be communicated to the client devices as probing information. In this regard, the probing information may provide an indication of specific sensor behavior to corresponding client device in the user group. The specific sensor data may be a particular pattern of data or information that may be known to or may be correlated to the occurrence of a certain condition. The associated sensors together with corresponding testing equipment and/or measuring instruments, for example, of the client device and/or one or more other client devices in the user group may be configured and/or activated based on the specific sensor behavior. User assessments may be communicated to the application server to build the data storage on the computing cloud.

In an exemplary embodiment of the invention, data traffic between remote instruments and the computing cloud and/or client devices may be categorized or managed based on corresponding QoS and/or latency requirements for the data traffic. In this regard, the remote instruments may utilize RSA encryption devices for extra security. In some instances, the data processing or data collection at the remote instruments may be tagged or combined as a function of time, for example, with corresponding measurement conditions such as position, orientation, temperature, and pressure as measured by the sensors available at the remote instruments. The combined data may then be transported or communicated to one or more devices such as the application servers and/or to other client devices. In some instances, the remote instruments 132(a)-132(d) may comprise a positioning system and/or orientation/accelerometer capabilities to report its position/orientation/speed data or the history of such data over time to the computing cloud 110 and/or the client devices 120. In this regard, the computing cloud 110 may utilize the location data of the remote instruments 132(a)-132(d) to signal or instruct the client devices 120(a)-120(c) to configure or restrict task/job assignments to the corresponding remote instruments 132(a)-132(d) based on their corresponding geographical locations.

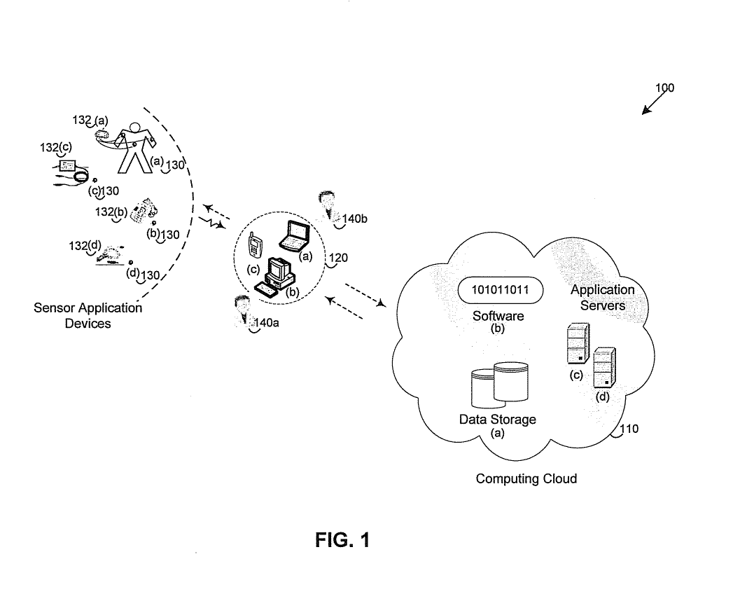

FIG. 1 is a diagram that illustrates an exemplary remote probing and data collection in a cloud computing environment, in accordance with an embodiment of the invention. Referring to FIG. 1, there is shown a cloud computing environment 100 comprising a computing cloud 110, client devices 120(a)-120(c) and sensors 130(a)-130(d).

The computing cloud 110 may comprise one or more servers and/or one or more computing devices that are operable to provide various services offered by the Internet. The term ‘cloud’ typically refers to the Internet and is based on the graphical depiction of the Internet as a cloud in computer network diagrams to represent the underlying infrastructure of the Internet. Infrastructure resources such as, for example, data storage 110(a) and software 110(b), on the computing cloud 110 may be provided to users as services. For example, the data storage 110(a) may be accessible to the client devices 120(a)-120(c) as remote shared memory to facilitate collection, processing and distribution of real live data. In this regard, the data storage 110(a) may be utilized by the client devices 120(a)-120(c) to remotely store data collected at various local data collection sites.

The application servers 110(c)-110(d) may be dedicated to running certain software applications or platforms in which the client devices 120(a)-120(c) connect to send commands and receive responses along with data content. An application server such as the application server 110(c) may be operable to retrieve or receive data that is collected at various local data collection sites. In an exemplary embodiment of the invention, the application server 110(c) may be operable to correlate the received data to create a user group comprising a collection of highly correlated client devices. For example, the user group may comprise those client devices that may share responsibilities and/or perform similar tasks. The application server 110(c) may identify available resources that may be associated with each client device of the user group. The identified available resources may comprise hardware resources, software resources, files, and/or data. For example, the identified available resources may comprise sensors, type of sensors and corresponding sensor applications in which the sensors are utilized. In an exemplary embodiment of the invention, the sensors 130(a)-130(d) may be utilized or deployed in sensor applications requiring a certain degree of precision and stability, for example, in electronic or electrical circuit and component test equipment, in medical testing equipment, semiconductor equipment, precision measuring instruments, aerospace applications, and/or military applications. For medical applications, the medical testing equipment may comprise audiometer, autoclave, hematocrit meter, glucometer, oxygen tank, microscope, electrocardiograph, spirometer, blood pressure measuring devices and scales, PH meters, electroencephalogram (EEG) monitoring unit, and/or thermometer. For electronic or electrical applications, the testing equipment may comprise ohmmeters, ammeters, voltmeters, insulation testers, power meters, relay testers, battery tester, probe cards, IC sockets, oscilloscopes, test lamps, analytical instrument, multifunction installation tester, multi-meters and recording instruments.

In an exemplary embodiment of the invention, the sensor application devices 132(a)-132(d) may act as remote equipment or instruments. For example, a smartphone and tablet owned by an ordinary user may act as a remote instrument for other client devices in accordance to some embodiments. In this case, the smartphone/tablet may comprise necessary hardware logic and software such as, for example, OS and/or applications to connect to the computing cloud 110 and/or the client devices 120(a)-120(c) to perform certain sensing or processing tasks.

Some other examples of the remote equipment or instruments 132(a)-132(d) may comprise a high resolution camera that may be controllable at a special location such as a stadium or a vacation destination, a temperature sensor, a microphone, a speaker, a cooking oven, a mechanical machine, an automobile, and/or a spectrum analyzer.

The application server 110(c) may share the identified available resources among the client devices that are in the entire user group. The application server 110(c) may communicate the available resource information to associated client devices 120(a)-120(c) in the user group as part of probing information. In this regard, client devices in the same user group may be operable to collect data from electronic probes or sensors located at different geographic locations. For example, the client devices 120(a) and 120(b) in the same user group of the application server 110(c) may be operable to collect data from electronic probes or sensors that are located at different university locations. Resources such as storage (hard drivers, memory, etc), processing and/or software applications available at the client device 120(a) may be shared by the client device 120(b), and vice versa.

In an exemplary embodiment of the invention, the application server 110(c) may process and aggregate the locally collected data supplied from an entire user group that comprises a collection of highly correlated client devices 120(a)-120(c) that are operable to track or monitor patients, for example, at various geographical locations. The application server 110(c) may utilize the aggregated data for trend analysis in real time or non-real-time. In this regard, for medical applications, the application server 110(c) may collect or retrieve patient data supplied from the client devices 120(a)-120(c) in the user group. The locally collected patient data may comprise body temperature, blood pressure, blood sugar levels, pulse rate, height and weight, and/or physical activity levels. The locally collected patient data may be processed and aggregated on the application server 110(c). The application server 110(c) may be operable to perform multiple diagnostics and analysis of trends over the user group utilizing the aggregated data and associated conditions for the locally collected patient data. The associated conditions may comprise information such as types of medical tests, reasons for ordering medical tests, specific medications, diagnoses, the way a clinician interprets the patient data, and geographic locations where the medical tests are performed. For electronic or electrical applications, the application server 110(c) may collect or retrieve data supplied from the client devices 120(a)-120(c) in the user group. The locally collected data may comprise measurement values of electrical resistance in ohms, electric current in amperes, electrical potential difference in volts, ohmic value, power levels, relay characteristics, battery conditions, and low leakage levels. The locally collected data may be processed and aggregated on the application server 110(c). The application server 110(c) may be operable to perform numerical analysis such as regression analysis for trend estimation over the user group utilizing the aggregated data and associated local measurement conditions. The associated local measurement conditions may comprise information with regard to types of local tests, environmental conditions such as temperature, air pressure, and moisture levels while performing the local tests, and geographical locations where the local tests are performed.

The application server 110(c) may list or identify possible causes and/or possible solutions based on, for example, the diagnostics and analysis of trends over the user group. The application server 110(c) may communicate the identified possible causes and possible solutions, success rates of the possible solutions, uncertainty levels of the possible solutions, associated environmental conditions, and/or medical prognosis to the client devices 120(a)-120(c) as part of probing information. In this regard, the probing information may provide an indication of specific sensor behavior to the client devices 120(a)-120(c) and this collected sensor data may be utilized for early detection, tracking and/or prediction of event occurrence. For example, a client device such as the client device 120(a) may determine or identify a specific sensor behavior based on the received probing information. More specifically, for medical application, for example, a user such as the user 140(a) of the client device 120(a) may choose or select a possible treatment option based on the received probing information for a patient under monitoring. The user 140(a) may determine or identify the specific sensor behavior from corresponding environmental conditions in the received probing information for the selected treatment option. The user may then remotely configure, via the client device 120(a), the associated patient sensors such as the sensors 130(a)-130(d) and corresponding sensor application devices such as medical testing equipment and/or measuring instruments 132(a)-132(d) to collect specified types of patient data such as blood pressure, blood sugar levels, and pulse rate for the selected treatment option. For electronic or electrical applications, a user such as the user 140(a) of the client device 120(a) may choose or select a possible local test option such as a dynamic-state relay testing based on the received probing information. The user 140(a) may determine or identify the specific sensor behavior from corresponding environmental conditions and geographic locations as indicated in the received probing information for the dynamic-state relay testing. The user may then remotely configure, via the client device 120(a), the associated sensors such as the sensors 130(a)-130(d) and corresponding sensor application devices such as testing equipment and/or electrical/electronic measuring instruments 132(a)-132(d) to collect power system condition information such as the system impedance ratio (SIR) for the dynamic-state relay testing.

In some embodiments of the invention, the remote instruments 132(a)-132(d) may comprise a sensor with analog outputs, and/or bank of analog-to-digital convertors (ADC). The digital outputs of ADCs may then be transported back to the cloud database/server centers of the computing cloud 110 in real time or offline. The sampling rate and bit-width of ADCs may be configurable by the client devices 120(a)-120(c) so as to optimize and balance between measurement accuracy/performance requirements and communication link throughput/latency requirements/capabilities. In some embodiments of the invention, the outputs of ADCs may be compressed (lossless or lossy data compression) and/or encrypted before transportation to the cloud data servers of the computing cloud 110.

In an exemplary embodiment of the invention, the probing information may be assessed by users of the client devices 120(a)-120(c). The application server 110(c) may receive user assessments supplied from the client devices 120(a)-120(c) to build the data storage 110(a) on the computing cloud 110. The computing cloud 110 may connect to the client devices 120(a)-120(c) via broadband connections. The broadband connections may comprise wired and/or wireless connections between the computing cloud 110 and the client devices 120(a)-120(c), wherein the wired portion may utilize coaxial cables, optical fibers, and/or other large bandwidth transmission medium.

The client devices 120(a)-120(c) may comprise suitable logic, circuitry, code, and/or interfaces that may be operable to receive data collected via the associated sensors 130(a)-130(d) at various data collection sites. In this regard, the client devices 120(a)-120(c) may be operable to collect data from electronic probes or sensors located at different geographic locations. The client devices 120(a)-120(c) may dispatch or forward the received data to appropriate cloud storage services such as the data storage 110(a) on the computing cloud 110. The data in the data storage 110(a) may be processed and aggregated by cloud platform services such as the application server 110(c). In this regard, the client devices 120(a)-120(c) may be operable to receive the resulting processed data from the application server 110(c). In an exemplary embodiment of the invention, the client devices 120(a)-120(c) may utilize the processed data to support appropriate applications or services such as remote patient monitoring and/or diagnostics.

In an exemplary embodiment of the invention, the client devices 120(a)-120(c) may receive probing information from the associated application server 110(c) to manage local probing. The received probing information may comprise available resources to be shared and/or specific sensor behavior for the client devices 120(a)-120(c). The client devices 120(a)-120(c) may be operable to utilize the received probing information to manage appropriate probing in terms of resource and sensor behavior. For example, the client device 120(a) may need resources such as testing equipment, electrical/electronic measuring instruments, and a memory or storage of the client device 120(b) in the same user group of the application server 110(c). As a result the testing equipment, the electrical/electronic measuring instruments, and the memory or storage of the client device 120(b) may be shared or utilized by the client device 120(a) when not being used by the client device 120(b).

In an exemplary embodiment of the invention, different scheduling mechanisms may be assigned by the computing cloud 110 to the client devices 120(a)-120(c) to allow or support different users/client access and utilize remote instrument resources. In some embodiments of the invention, the pricing (per minute, per hour, flat rate, etc.) may be configured based on time of access (time of the day, time of the year). In some embodiments, the price may be set as a function of demand/requests to access a remote instrument. In some embodiments, different client devices 120(a)-120(c) may bid for accessing the remote instrument 132(a) for a specific date/time and a period of utilization.

In an exemplary embodiment of the invention, the remote instruments 132(a)-132(d) may comprise a positioning system and/or orientation/accelerometer capabilities to report its position/orientation/speed data or the history of such data over time to the computing cloud 110 and/or the client devices 120. The positioning system may comprise GPS and/or WiFi-based positioning method. The location data of the remote instruments 132(a)-132(d) may be used by the computing cloud 110 to configure/restrict task/job assignments to the remote instruments 132(a)-132(d) based on their corresponding geographical locations. For example, only remote instruments within a certain location region may be utilized or assigned for certain tasks or jobs by the computing cloud 110. In another example, an ordinary user with an iPad in location (x,y,z) may allow other client devices to connect to his/her iPad and configure and use its camera or temperature sensor for capturing and sending back video streams through the iPad's camera at location (x,y,z).

In some embodiments of the invention, the remote sensors and/or instruments may be part of a large inventory/bank of resources with a range of capabilities/features. A client user such the user 140(a) may then be given the option to identify a remote instrument/hardware that meets the client's required features/capabilities. For example, the remote bank of hardware instruments may comprise FPGA boards with different FPGA device categories and logic capacities. The client user 140(a) may select an FPGA hardware that may be utilized to implement and fit the amount of logic required for client's task. In another example, the instruments may comprise different dynamic range and resolution specifications. The client user 140(a) may be given the option to select the remote instrument that meets the client's specification requirements.

In an exemplary embodiment of the invention, the client devices 120(a)-120(c) may be operable to configure or calibrate the associated sensors 130(a)-130(d) and corresponding sensor application devices or units such as the medical testing equipment and/or electrical/electronic measuring instruments 132(a)-132(d) for the specific sensor behavior as indicated in the probing information. For example, the client device 120(a) may set or configure the associated sensors 130(a)-130(d) and the corresponding medical testing equipment and/or electrical/electronic measuring instruments 132(a)-132(d) based on the corresponding environmental conditions and geographic locations for a possible treatment or local testing option. In another example, the user 140(a) of the client device 120(a) may assess or evaluate probing information supplied from the application server 110(c) and feedback the resulting user assessments to the application server 110(c) to build the data storage 110(a) on the computing cloud 110. For medical application, the user assessments may comprise quantity of drugs or alcohol consumed, and/or blood test results, for example. For electronic or electrical applications, the user assessments may comprise analysis of measurement errors, which may comprise the evaluation of uncertainty in measurement data, confident range associated with the measurement data and/or the causes for the measurement errors. In another example, the user 140(a) of the client device 120(a), a university student in New York, for example, may utilize or evaluate the probing information supplied from the application server 110(c) to identify available test equipment of the client device 120(b), which may be located at different geographic locations such as at Berkeley in CA. The university student in New York may be enabled to utilize the identified available test equipment at Berkeley in CA whenever it is not being utilized by the client device 120(b).

The sensors 130(a)-130(d) may comprise suitable logic, circuitry, code, and/or interfaces that may be operable to acquire or collect sensor data and transmit the collected sensor data to appropriate cloud storage services such as the data storage 110(a) via the client devices 120(a)-120(c). In an exemplary embodiment of the invention, the sensors 130(a)-130(d) may be associated with or utilized in various sensor application devices or units such as medical testing equipment, semiconductor equipment, electrical and electronic components, circuits, instruments and equipment, and/or measuring instruments 132(a)-132(d). In an exemplary embodiment of the invention, the sensors 130(a)-130(d) and the corresponding testing equipment and/or measuring instruments 132(a)-132(d), for example, may be remotely configured and/or calibrated by the associated client devices 120(a)-120(c). For example, the sensors 130(a)-130(d) may be configured or activated by the client devices 120(a)-120(c) to collect specified data such as the blood pressure data, pulse rate, activity levels, circuit resistance values, and/or system power levels. The sensors 130(a)-130(d) and the corresponding testing equipment, electrical and electronic components, circuits, instruments and equipment and/or measuring instruments 132(a)-132(d) may also be reconfigured, calibrated or deactivated by the client devices 120(a)-120(c) as needed. The sensors 130(a)-130(d) and the corresponding testing equipment and/or measuring instruments 132(a)-132(d) may be located at different geographic locations such as different university locations.

In operation, the sensors 130(a)-130(d) utilized in the corresponding testing equipment and/or measuring instruments 132(a)-132(d), for example, may be activated for taking data measurements. In some instances, the sensors 130(a)-130(d) and the corresponding testing equipment and/or measuring instruments 132(a)-132(d) are configured to track vital body signs to acquire or collect patients' data, and/or probe electrical or electronic devices to get simulation or test information. The collected data may be communicated to the client devices 120(a)-120(c) via wireless communication such as Bluetooth low energy (BLE) communication or Wi-Fi communication. The client devices 120(a)-120(c) may store the locally collected data or electrical or electronic probing data into the data storage 110(a) on the computing cloud 110. An application platform service such as the application server 110(c) may be operable to process and aggregate the locally collected data over the entire client devices in an associated user group. In this regard, the application server 110(c) may perform analysis of trends utilizing the aggregated data over the user group. For medical applications, multiple diagnosis may be performed utilizing the aggregated data. Possible treatment options for a patient or group of patients monitored by the client device 120(a), for example, may be determined based on the trends or patterns identified in the aggregated data. For electronic or electrical applications, probing information from multiple locations may be aggregated and results based on different localities and test conditions may be assessed in order to determine trends. Available resources, for example, sensor application devices such as the testing equipment and/or measuring instruments 132(a)-132(d), and indication of specific sensor behavior may be communicated by the application server 110(c) as probing information to the client devices 120(a)-120(c). The client devices 120(a)-120(c) may utilize the probing information to manage and/or configure the operation of the associated sensors 130(a)-130(d) and the corresponding sensor application devices such as the testing equipment and/or measuring instruments 132(a)-132(d) for specific sensor behavior. For example, the sensor 130(a) currently being utilized by the client device 120(a) may be deactivated and the sensor 130(b) may be activated by the client device 120(a) based on the probing information. Users of the client device 120(a) may analyze or assess the probing information, and feedback user assessment to the application server 110(c) to build the user storage 110(a).

In some embodiments of the invention, the data traffic between the remote instruments 132(a)-132(d) and the computing cloud 110 and/or the client devices 120 may be categorized based on QoS and/or latency requirements. For the same client's usage case, the traffic may be partitioned into different categories based on, for example, QoS and/or latency requirements. For example, the data downlink from the computing cloud 110 and/or the client devices 120 to the remote instrument 132(a)-132(d) may require a very low-latency high-throughput link. In this case a higher bandwidth channel may be allocated to the downlink channel. However, the same remote instrument 132(a)-132(d) may require a relaxed latency specification for uplink from the instrument 132(a)-132(d) to the computing cloud 110 and/or the client devices 120. In this case the uplink data transfer may be scheduled for an off-peak time slot and/or utilize a lower-bandwidth channel.

In some embodiments of the invention, the remote electrical instruments 132(a)-132(d) may comprise configurable hardware such as FPGA devices where a client user may access and configure/program for a specific application or task. Once the remote configurable hardware is allocated to a client device and programmed accordingly, the client device may the n use the remote hardware to perform data collection and/or data processing and send back the results to the cloud servers 110(c)-110(d) and data centers such as the user storage 110(a). At the end of a session, but before another client accesses the hardware, all programming/configuration and local data within the remote hardware may be wiped out or erased for privacy/security reasons.

In some embodiments of the invention, the link between the computing cloud 110 and/or the client devices 120 to the remote instruments 132(a)-132(d) may be encrypted for security reasons. Also, any temporary data stored locally at a remote instrument 132(a) may be encrypted with different keys for a client device 120(a) or job. For example, in the case of a remote FPGA hardware 132(c), the programming file or data submitted by a client device 120(b) may be encrypted and stored locally at the remote FPGA hardware 132(c).

In some embodiments of the invention, the remote instruments 132(a)-132(d) may be operable to deploy or utilize RSA encryption devices for extra security. In this usage case, a client device such as the client device 120(a) that attempts to access and utilize a remote instrument such as the remote instrument 132(a), may be asked to provide the matching RSA identification number to the RSA embedded device in the remote instruments 132(a)-132(d).

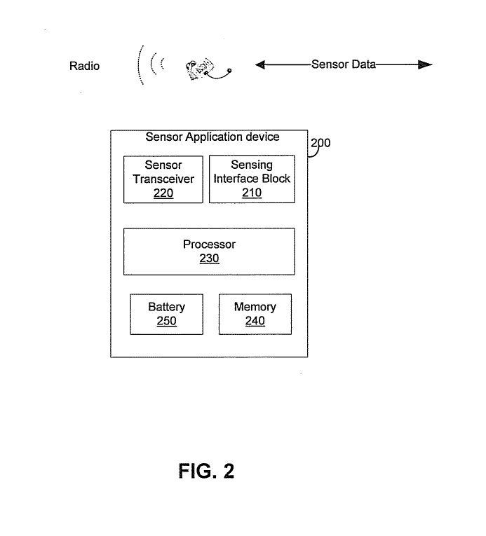

FIG. 2 is a block diagram that illustrates an exemplary sensor application device that is operable to acquire sensor data in a cloud computing environment, in accordance with an embodiment of the invention. Referring to FIG. 2, there is shown a wireless sensor application device 200 comprising a sensing interface module 210, a sensor transceiver 220, a processor 230, a memory 240, and a battery 250.

The sensing interface module 210 may comprise suitable logic, circuitry, interfaces, and/or code that may be operable to sense and collect sensor data from a target device. The sensing interface module 210 may communicate the collected sensor data to the processor 230 for further analysis.

The sensor transceiver 220 may comprise suitable logic, circuitry, interfaces and/or code that may be enabled to transmit and/or receive radio frequency (RF) signals such as short range RF signals and convert them to corresponding baseband signals, which may be suitable for further processing such as patient data processing in the processor 230 for medical applications. In other embodiments of the invention, the sensor transceiver 220 may use ultrasound signals, optical signals, or a wire connection.

The processor 230 may comprise suitable logic, circuitry, interfaces and/or code that may be enabled to perform a variety of signal processing tasks such as calculating of pulse rate and blood sugar levels for medical applications. The processor 230 may be operable to coordinate and control operations of the sensor transceiver 220 as well as the sensing interface module 210. For example, the processor 230 may manage, activate or deactivate the sensing interface module 210 according to messages received from the associated client device 120(a) via the sensor transceiver 220. For example, if the wireless sensor application device 200 comprises the battery 250 and its corresponding battery level is low, then the processor 230 may be operable to deactivate the sensor application device 200 or put it into a low power state.

The processor 230 may also be operable to synchronize the operation of the sensor transceiver 220 and the sensing interface module 210 so as to reduce time delay for the delivery of the collected sensor data to the client device 120(a). The processor 230 may be enabled to process various sensor data collected from the target device via the sensing interface module 210. For medical applications, the collected sensor data may comprise, for example, body temperature, blood pressure, blood sugar levels, pulse rate, height and weight, and/or physical activity levels. For electronic or electrical applications, the collected sensor data may comprise, for example, measurement values of electrical resistance in ohms, electric current in amperes, electrical potential difference in volts, ohmic value, power levels, relay characteristics, battery conditions, and low leakage levels. The collected sensor data may be communicated via the sensor transceiver 220 to the associated client devices 120(a)-120(c) for data processing.

In an exemplary embodiment of the invention, the processor 230 may receive probing information via the sensor transceiver 220 from the application server 110(c) on the computing cloud 110. The processor 230 may be operable to determine or select specific sensor behavior such as types of sensors and/or types of data to be collected based on the received probing information. The processor 230 may be operable to configure the wireless sensor application device 200 based on the specific sensor behavior. In this regard, the processor 230 may manage and/or calibrate the wireless sensor application device 200 for the specific sensor behavior. For example, in some instances, the probing information comprises a different sensor data measurement such as pulse rate measurement for possible treatment options. The processor 230 may signal the associated sensors 130(a)-130(d) to sense or collect the specific types of sensor data via the sensing interface module 210.

The memory 240 may comprise suitable logic, circuitry, interfaces and/or code that may enable storage of data and/or other information utilized by the processor 230. For example, the memory 240 may be utilized to store sensor data collected via the sensing interface module 210. The memory 240 may be enabled to store executable instructions received from the sensor transceiver 220 to manage or configure sensor behavior, for example, types of sensor and types of sensor data. The memory 240 may comprise RAM, ROM, low latency nonvolatile memory such as flash memory and/or other suitable electronic data storage capable of storing data and instructions.

The battery 250 may comprise suitable logic, circuitry, interfaces and/or code that may be operable to read or receive electric current flowing into the battery 250. The battery 250 may output electric power to support desired applications running on the wireless sensor application device 200.

In operation, the processor 230 may be instructed or signaled to configure and/or calibrate the wireless sensor application device 200 to detect the specific sensor behavior based on the probing information received by the associated client device 120(a) from the application server 110(c). In this regard, the sensing interface module 210 may be activated or deactivated based on instructions received from the associated client device 120(a). In instances where the sensing interface module 210 is activated for certain types of sensor data, the sensing interface module 210 may be enabled to sense or collect the sensor data from a target object. The collected sensor data may be communicated with the processor 230. The processor 230 may deliver the sensor data to the client device 120(a) via the sensor transceiver 220. The delivered sensor data may be processed by the application server 110(c) on the computing cloud 110.

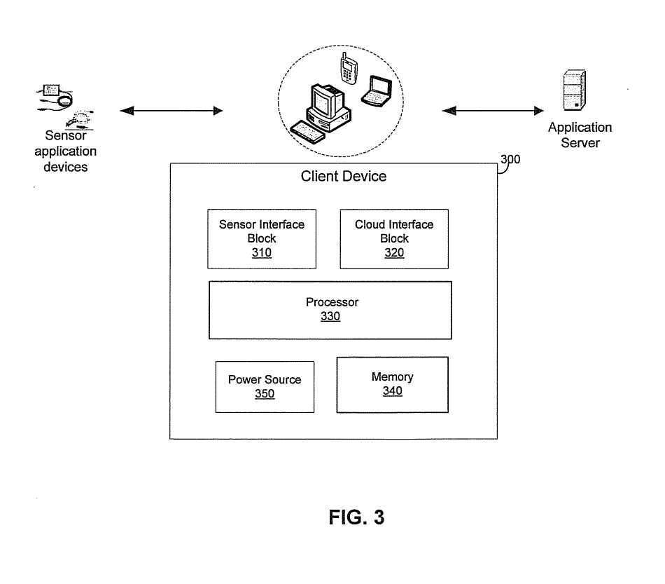

FIG. 3 is a block diagram that illustrates an exemplary client device that is operable to remotely configure and calibrate sensors with the assistance of a cloud server platform, in accordance with an embodiment of the invention. Referring to FIG. 3, there is shown a client device 300. The client device 300 may comprise a sensor interface module 310, a cloud interface module 320, a processor 330, a memory 340, and a power source 350.

The sensor interface module 310 may comprise suitable logic, circuitry, interfaces and/or code that may be enabled to transmit and/or receive radio frequency (RF) signals such as short range RF signals and convert them to corresponding baseband signals suitable for baseband processing in the processor 330. In other embodiments of the invention, the sensor interface module 310 may use ultrasound signals, optical signals, or a wire connection.

The cloud interface module 320 may comprise suitable logic, circuitry, interfaces and/or code that may be enabled to communicate with the computing cloud 110 for appropriate cloud services such as the data storage 110(a) and the application server 110(c). The cloud interface module 320 may be configured to support multiple ports such as High-Definition Multimedia Interface (HDMI), Ethernet Physical Layer (PHY), Universal Serial Bus (USB), and RS232, for example. Other types of connections, protocols, and/or ports may also be supported.

The processor 330 may comprise suitable logic, circuitry, interfaces and/or code that may be enabled to perform a variety of signal processing tasks. The processor 330 may perform tasks such as controlling of the sensor interface module 310 as well as the cloud interface module 320, for example. The processor 330 may be enabled to transmit data that is received via the sensor interface module 310 to the application server 110(c) for data processing such as diagnostics processing. In an exemplary embodiment of the invention, the processor 330 may receive the resulting processed data and/or probing information from the computing cloud 110 via the cloud interface module 320. The processor 330 may determine available resources in an associated user group from the probing information. For example, in instances where the client device 300 needs certain resources such as testing equipment, electrical/electronic measuring instruments, processing, computing power, and/or storage (for example, buffering, caching, storing), software application and/or a file of the client device 120(b) in the same user group as the client device 300, the processor 330 may communicate with the application server 110(c) so as to share the testing equipment, electrical/electronic measuring instruments, processing, computing power, and/or storage software application and the file of the client device 120(b) whenever available for sharing.

In an exemplary embodiment of the invention, the probing information may provide an indication of specific sensor behavior for the client device 300. For example, the probing information may comprise probing information such as types of probing, types of data to be collected and corresponding location or environment where the probing is performed. The processor 330 may utilize the specific sensor behavior to remotely manage and/or calibrate associated sensors such as the sensors 130(a)-130(d), accordingly. For example, in some instances, for medical applications, the probing information comprises a possible treatment option for a patient monitored through the client device 300. The possible treatment option may require certain types of sensor data such as pulse rate data and urine test data. In this regard, the processor 330 may activate particular sensors and sensor applications capable of collecting the specific types of patient data required for the possible treatment option.

For electronic or electrical applications, the probing information comprises one or more possible local test options for sensors and corresponding sensor application devices managed by the client device 300. The possible local test options may require certain types of sensor data such as electric current values and power values. In this regard, the processor 330 may activate particular sensors and sensor applications capable of collecting the specific types of sensor data required for the possible local test options.

In an exemplary embodiment of the invention, users such as the user 140(a) of the client device 300 may evaluate or assess the probing information. The processor 330 may feedback the user assessment to the application server 110(c) to build the data storage 110(a).

The memory 340 may comprise suitable logic, circuitry, interfaces and/or code that may enable storage of data and/or other information utilized by the processor 330. For example, the memory 340 may be utilized to store sensor data received via the sensor interface module 310. The memory 340 may be enabled to store executable instructions to manage sensor behavior, sensor calibration and sensor configuration. The memory 340 may comprise RAM, ROM, low latency nonvolatile memory such as flash memory and/or other suitable electronic data storage capable of storing data and instructions.

The power source 350 may comprise suitable logic, circuitry, interfaces and/or code that may be operable to read or receive electric current flowing into the power source 350. The power source 350 may output electric power to support desired applications running on the wireless sensor application device 200.

In operation, the sensor interface module 310 may be enabled or activated to retrieve sensor data captured by the associated sensors 130(a)-130(d). The processor 330 may forward the received sensor data to appropriate cloud services such as the application server 110(c) via the cloud interface module 320. The application server 110(c) may be operable to process and aggregate the sensor data. The resulting processed data and/or probing information may be provided back to the client device 300. In this regard, the received probing information may provide the client device 300 with an indication of available resources such as testing equipment for sharing and specific sensor behavior such as types of probing and types of data that is to be collected by the client device 300. For medical applications, for example, based on the probing information, the client device 300 may perform probing of patient body functions for specific types of patient data such as, for example, body temperature, blood pressure, blood sugar levels, pulse rate, periods of activities, period of inactivity, and/or patient body position. Patient body position may indicate whether the patient is standing, sitting down, and/or laying down. The client device 300 may remotely configure and/or calibrate associated patient sensors such as the sensors 130(a)-130(d), for example, to collect the specific types of patient data such as pulse rate, blood sugar levels, and urine test data through the corresponding sensor application devices 132(a)-132(d), respectively, for probing of patient body. The collected data may be processed by the corresponding remote instruments 132(a)-132(d), respectively.

In some embodiments of the invention, the remote instruments 132(a)-132(d) may comprise one or more video/image cameras where the collected data may be tagged, combined, or accompanied by the data collected through the cameras. The combined data may then be transported or communicated to the computing cloud 110 and/or the client devices 120(a)-120(c). The combined data may comprise voice data captured through several microphones as well. In some embodiments of the invention, the data processing or data collection at the remote instrument may be tagged as a function of time, for example, with position, orientation, temperature, pressure, etc. as measured by the sensors 130(a)-130(d) available at the remote instruments 132(a)-132(d).

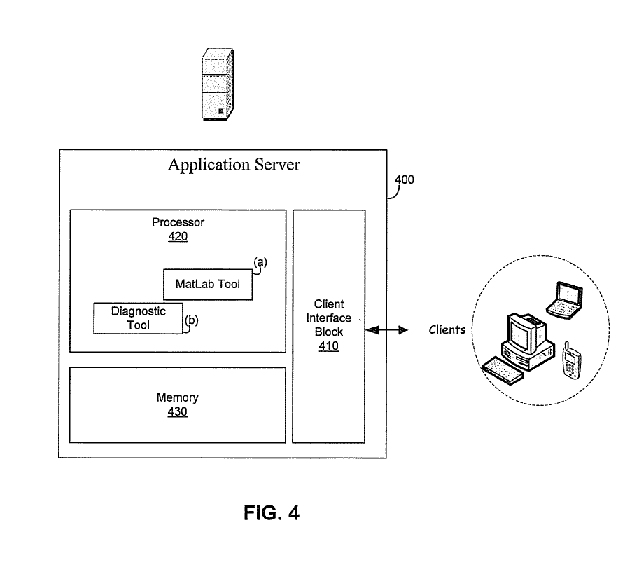

FIG. 4 is a diagram illustrating an exemplary cloud server platform that is operable to provide assistance for remote probing and data collection, in accordance with an embodiment of the invention. Referring to FIG. 4, there is shown an application server 400 on the computing cloud 110. The application server 400 may comprise a client interface module 410, a processor 420 and a memory 430.

The client interface module 410 may comprise suitable logic, circuitry, interfaces and/or code that may be enabled to communicate with the client devices 120(a)-120(c). In this regard, the client interface module 410 may enable the client devices 120(a)-120(c) to access appropriate cloud services such as the data storage 110(a) and the application server 110(c), for example. The client interface module 410 may be configured to support multiple ports such as High-Definition Multimedia Interface (HDMI), Ethernet Physical Layer (PHY), Universal Serial Bus (USB), and RS232, for example. Other types of connections, protocols, and/or ports may also be supported.

The processor 420 may comprise suitable logic, circuitry, interfaces and/or code that may be enabled to perform a variety of signal processing tasks and may comprise controlling of the client interface module 410, for example. The processor 420 may be operable to retrieve or receive data that is collected at various local data collection sites. For medical applications, the collected data may comprise patients' data. The locally collected patients' data may comprise body temperature, blood pressure, blood sugar levels, pulse rate, periods of activities, period of inactivity, and/or patient, body position. For electronic or electrical applications, the collected data may comprise measurements of power levels, circuit resistance values, electric current, and electric voltage values, for example, and corresponding measurement conditions and geographic location.

The processor 420 may utilize various software testing tools such as, for example, a MatLab tool 420(a) and a diagnostic tool 420(b), to process the locally collected data. For example, the MatLab tool 420(a) comprises a high performance interactive software package for scientific and engineering computation. The Matlab tool 420(a) may integrate numerical analysis, matrix computation, signal processing and graphics to a numerical computing environment. For medical applications, the diagnostic tool 420(b) may enable a wide-range of programmable and reconfigurable services with efficient remote monitoring for mobile patient care. The diagnostic tool 420(b) may be operable to process the locally collected patients' data for remote patient monitoring and diagnosis, and/or for equipment testing.

In an exemplary embodiment of the invention, the processor 420 may be operable to correlate the locally collected data such as patients' data to create a user group with a collection of highly correlated client devices such as the client devices 120(a)-120(c). The processor 420 may identify available resources from each client device in the user group for sharing. The available resources may comprise hardware resources, software resources, files, and/or data. The processor 420 may inform the associated client devices 120(a)-120(c) of the available resources that may be shared in the user group. Client devices such as the client devices 120(a) and 120(b) located at different geographic locations in the same user group of the application server 110(c) may share resources from one to another. For example, the user of the client device 120(a) may be enabled to share resources such as medical testing equipment and patient data analysis report of the client device 120(b), and vice versa. More specifically, the user 140(a) of the client device 120(a) may be enabled to share or utilize test equipment and/or electric/electrical measuring instrument that are managed by the client device 120(b) but may be located at different geographic locations.

In an exemplary embodiment of the invention, for medical applications, the processor 420 may be operable to aggregate the locally collected patients' data for medical prognosis, trend analysis and possible treatment options, for example. In this regard, the processor 420 may perform multiple diagnostics and analysis of trends utilizing the aggregated data over the entire user group. For example, the processor 420 may be operable to identify or determine possible causes and possible treatment options based on the trends or patterns identified in the aggregated data. The processor 420 may inform the associated client devices 120(a)-120(c) of the possible causes, the possible treatment options, and associated environmental conditions. The environmental conditions may comprise types of probes, types of data that may be collected, types of analysis that may be done, and geographic locations where the test is performed.

For electronic or electrical applications, the processor 420 may be operable to aggregate the locally collected data that may comprise measurement values such as electrical resistance values, electric current values, electrical voltage values, power levels, and/or battery conditions. In this regard, the processor 420 may perform various numerical analysis such as regression analysis for trend analysis utilizing the aggregated data over the entire user group. For example, the processor 420 may be operable to identify or determine possible causes and possible local test options based on the trends or patterns identified in the aggregated data. The processor 420 may inform the associated client devices 120(a)-120(c) of the possible causes, the possible local test options, and associated environmental conditions. The environmental conditions may comprise types of local test, types of data that may be collected, types of analysis that may be done, and geographic locations where the test is performed.

The processor 420 may generate probing information for the user group utilizing available resources in the associated user group, possible causes, the possible treatment and/or local test options, and/or corresponding environmental conditions. The processor 420 may communicate the probing information to the client devices 120(a)-120(c) whenever needed. The processor 420 may enable the client devices 120(a)-120(c) resource sharing and remote sensor configuration and/or calibration based on the probing information. In some instances, users of the client devices 120(a)-120(c) may assess the probing information and feedback to the application server 400. For example, for medical applications, a medical doctor may assess the probing information received by the associated client device 120(a) from the processor 420. The medical doctor may feedback the resulting user assessment back to the application server 400. The user assessment may comprise information such as success rate, body temperature, blood pressure, blood sugar levels, pulse rate, periods of activities, period of inactivity, and/or patient body position with regard to the medical prognosis options in the probing information, for example. For electronic or electrical applications, a technician may assess the probing information received by the associated client device 120(a) from the processor 420. The university student in New York may feedback the resulting user assessment back to the application server 400. The user assessment may comprise information such as uncertainty levels of measurement data, confident range associated with the measurement data and/or what are the causes for the measurement errors. The processor 420 may utilize the received user assessments to build the data storage 110(a) on the computing cloud 110.

The memory 430 may comprise suitable logic, circuitry, interfaces and/or code that may enable storage of data and/or other information utilized by the processor 420. For example, the memory 430 may be utilized to store various sensor data such as patients' sensor data received via the client interface module 410. The memory 430 may be enabled to store executable instructions to manage sensor behavior, sensor calibration and sensor configuration. The memory 430 may comprise RAM, ROM, low latency nonvolatile memory such as flash memory and/or other suitable electronic data storage capable of storing data and instructions.

In an exemplary operation, the application server 400 may communicate with associated client devices such as the client devices 120(a)-120(c) for various application services such as patient remote diagnostics. The processor 420 may be operable to retrieve or receive data such as patients' data from the client devices 120(a)-120(c). The retrieved patient data may be collected via the sensors 130(a)-130(d) that may be located at various local data collection sites. The processor 420 may run the MatLab tool 420(a), the diagnostic tool 420(b), and/or other simulation and data analysis tools to process the locally collected data. The processor 420 may identify available resources in a user group with a collection of highly correlated client devices 120(a)-120(c). The processor 420 may manage the client devices 120(a)-120(c) for resource sharing over the user group. For example, resources available at one particular client device such as the client device 120(a) in the user group may be shared by other client devices such as the client devices 120(b)-120(c) when the resources are not being utilized by the client device 120(a). The processor 420 may aggregate the locally collected data over the entire user group. The processor 420 may utilize the diagnostic tool 420 (b), for example, to perform multiple diagnostics and analysis of trends utilizing the aggregated patient data over the user group. Possible causes, possible treatment or local test options, and/or medical prognosis may be determined based on the trends or patterns identified in the aggregated data. The processor 420 may form probing information for the user group utilizing the identified available resource information, possible causes, possible treatment or local test options, medical prognosis, and corresponding environment conditions. The processor 420 may provide the probing information to the client devices 120(a)-120(c) in the user group. The probing information may be utilized by each client device such as the client device 120(a) for remote patient monitoring, and/or local sensor configuration and calibration.

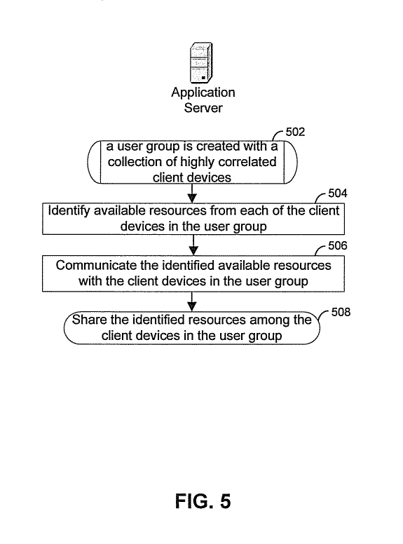

FIG. 5 is a flow diagram that illustrates exemplary steps performed by a cloud application service for resource sharing, in accordance with an embodiment of the invention. Referring to FIG. 5, in step 502, the application server 400 on the computing cloud 110 may be operable to select a collection of highly correlated client devices such as the client devices 120(a)-120(c) to form a user group for the application server 400. The exemplary steps start in step 504, where the application server 400, may communicate each of the client devices 120(a)-120(c) in the user group to identify available resources for sharing. In step 506, the application server 400 may communicate information with regard to the identified available resources to the client devices 120(a)-120(c). In step 508, the application server 400 may manage the client devices 120(a)-120(c) to share the identified available resources such as testing equipment and/or electronic or electrical measuring instruments in the user group.

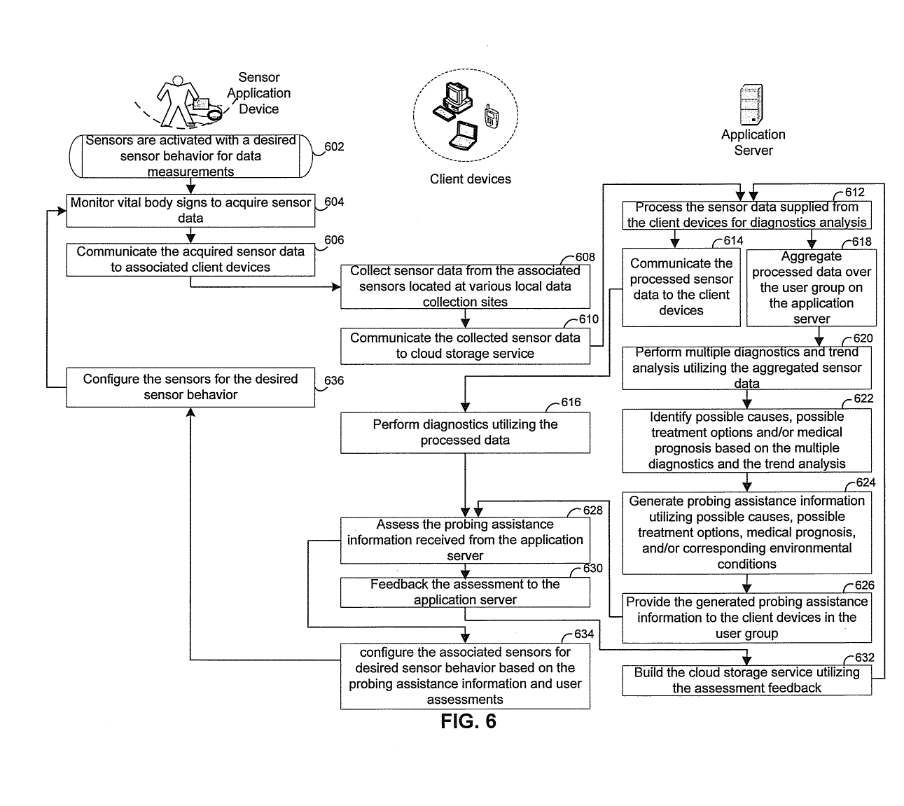

FIG. 6 is a flow diagram that illustrates exemplary steps for remote patient monitoring in a cloud computing environment, in accordance with an embodiment of the invention. Referring to FIG. 6, in step 602, the sensors 130(a)-130(d) utilized in the corresponding sensor application devices 132(a)-132(d) are activated with specific sensor behavior such as types of probes, types of data that may be collected, and types of analysis that may be done. For example, the sensor application devices 132(a)-132(d) may signal or instruct the sensors 130(a)-130(d) with preferred sensor parameter values for the specific sensor behavior. The sensors 130(a)-130(d) may activate themselves utilizing the preferred sensor parameter values signaled from the sensor application devices 132(a)-132(d). The exemplary steps start with step 604, where the sensors 130(a)-130(d) may be operable to monitor vital body signs to acquire sensor data. In step 606, the sensors 130(a)-130(d) may communicate the acquired sensor data to the associated client devices 120(a)-120(c) through the corresponding sensor application devices 132(a)-132(d), respectively. In step 608, the client devices 120(a)-120(c) may be enabled to collect sensor data captured by the sensors 130(a)-130(d) located at various local data collection sites. For example, the sensors 130(a)-130(d) may be located at different university locations. In step 610, the collected sensor data may be communicated to cloud storage services such as the data storage 110(a). In step 612, cloud server platform services such as the application server 110(c) may process the sensor data supplied from the client devices 120(a)-120(c) for diagnostic analysis. The exemplary steps proceed in step 614 and in step 618, respectively. In step 614, the application server 110(c) may communicate the processed sensor data back to the client devices 120(a)-120(c). In step 616, the client devices 120(a)-120(c) may utilize the processed sensor data to perform diagnostics analysis. The exemplary steps continue in step 628.

In step 618, the application server 110(c) may aggregate the processed data over the entire user group on the application server 110(c). In step 620, the application server 110 (c) may perform multiple diagnostics and trend analysis utilizing the aggregated sensor data. In step 622, the application server 110(c) may identify possible causes, possible treatment options and/or medical prognosis based on the multiple diagnostics and the trend analysis. In step 624, the application server 110(c) may generate probing information comprising possible causes, possible treatment options, medical prognosis, and/or corresponding environmental conditions. In step 626, the application server 110(c) may provide the generated probing information to the client devices in the user group. The exemplary steps continue in step 628.

In step 628, users of the client devices 120(a)-120(c) in the user group may assess the probing information supplied from the application server 110(c). The exemplary steps proceed in step 630 and in step 634, respectively.

In step 630, the client devices 120(a)-120(c) may feedback the user assessment to the application server 110(c). In step 632, the computing cloud 110 may utilize the user assessment from the client devices 120(a)-120(c) to build the data storage 110(a).

In step 634, the users of the client devices 120(a)-120(c) in the user group may configure the associated sensors and the corresponding sensor application devices such as testing equipment and/or measuring instruments for specific sensor behavior based on the probing information and user assessments. In step 636, the sensors 130(a)-130(d) may be configured for the specific sensor behavior based on instructions from the associated client devices 120(a)-120(c). The exemplary steps return to step 604.

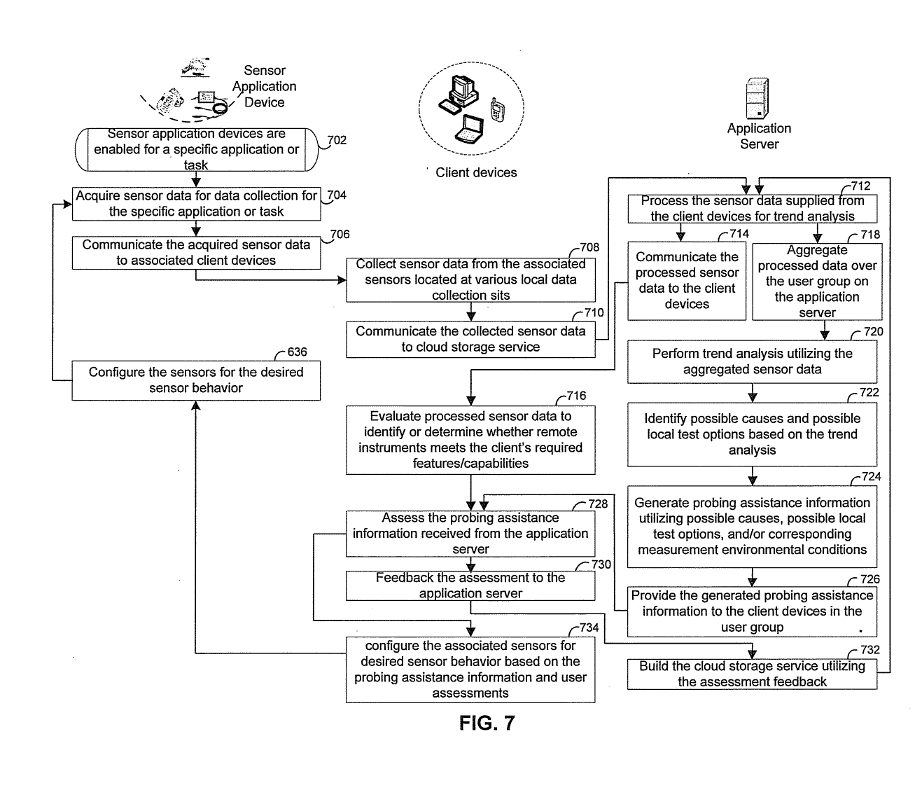

FIG. 7 is a flow diagram that illustrates exemplary steps for managing remote test instruments in a cloud computing environment, in accordance with an embodiment of the invention. Referring to FIG. 7, in step 702, the remote instruments 132(a)-132(d) may be identified and enabled to be shared and utilized among the client devices 120(a)-120(c) for a specific application or task. The exemplary steps start with step 704, where the corresponding sensors 130(a)-130(d) may be operable to acquire sensor data for data collection for the specific application or task. In step 706, the remote instruments 132(a)-132(d) may process and communicate the acquired sensor data to the associated client devices 120(a)-120(c), respectively. In step 708, the client devices 120(a)-120(c) may be enabled to collect sensor data captured by the sensors 130(a)-130(d) located at various local data collection sites. For example, the sensors 130(a)-130(d) may be located at different university locations. In an exemplary embodiment of the invention, the remote instruments 132(a)-132(d) may comprise a positioning system and/or orientation/accelerometer capabilities to report its position/orientation/speed data or the history of such data over time to the computing cloud 110 and/or the client devices 120. The location data of the remote instruments 132(a)-132(d) may be used by the computing cloud 110 to configure/restrict task/job assignments to the remote instruments 132(a)-132(d) based on their corresponding geographical locations. In this regard, the remote instruments 132(a)-132(d) may communicate the acquired sensor data together with its position/orientation/speed data or the history of such data to the associated client devices 120(a)-120(c), respectively. In step 710, the collected sensor data may be communicated to cloud storage services such as the data storage 110(a) via the client devices 120. In step 712, cloud server platform services such as the application server 110(c) may process the sensor data supplied from the client devices 120(a)-120(c). The exemplary steps proceed in step 714 and in step 718, respectively. In step 714, the application server 110(c) may communicate the processed sensor data back to the client devices 120(a)-120(c). In step 716, the client devices 120(a)-120(c) may evaluate the processed sensor data to identify or determine whether the remote instruments 132(a)-132(d) meet the client's required features/capabilities. The exemplary steps continue in step 728.

In step 718, the application server 110(c) may aggregate the processed data over the entire user group on the application server 110(c). In step 720, the application server 110 (c) may perform various numerical analysis such as regression analysis for trend analysis utilizing the aggregated data over the entire user group. In step 722, the application server 110(c) may identify or determine possible causes and possible local test options based on the trends or patterns identified in the aggregated data. In step 724, the application server 110(c) may generate probing information comprising possible causes, the possible local test options, and associated environmental conditions. In step 726, the application server 110(c) may provide the generated probing information to the client devices in the user group. The exemplary steps may continue in step 728.

In step 728, users of the client devices 120(a)-120(c) in the user group may assess the probing information supplied from the application server 110(c). The exemplary steps proceed in step 730 and in step 734, respectively.

In step 730, the client devices 120(a)-120(c) may feedback the user assessment to the application server 110(c). In step 732, the computing cloud 110 may utilize the user assessment from the client devices 120(a)-120(c) to build the data storage 110(a).

In step 734, the users of the client devices 120(a)-120(c) in the user group may configure the associated sensors and the corresponding sensor application devices such as testing equipment and/or measuring instruments for specific sensor behavior based on the probing information and user assessments. In step 736, the sensors 130(a)-130(d) may be configured for the specific sensor behavior based on instructions from the associated client devices 120(a)-120(c). The exemplary steps may return to step 704.

In various exemplary aspects of the method and system for server-assisted remote probing and data collection in a cloud computing environment, the computing cloud 110 may comprise various cloud services such as the data storage service provided by the data storage 110(a) and the application server service provided by the application server 110(c). These cloud services may be utilized to serve a plurality of client devices such as the client devices 120(a)-120(c). The client device 120(a) may receive probing information from the application server 110(c). The probing information may be generated by the application server 110(c) utilizing sensor data that may be collected from a plurality of local data collection sites or from distributed collection sites or points. The distributed collection sites or points may be geographically or remotely dispersed. The client device 120(a) may manage associated sensors based on the received probing information and also based on a category of data traffic handled by the associated sensor. The sensors may comprise programmable sensors. The sensors may be programmed and/or configured to handle one or more local or remotely assigned tasks based on the received probing information and the category of the data traffic. The sensor data may be collected or captured by one or more associated sensors together with corresponding sensor applications, which may be managed by the client device 120(a) and by one or more sensors together with corresponding sensor applications, which may be managed by one or more other client devices such as client devices 120(b)-120(c). For example, the sensors may be configured based on the received probing information. The client devices 120(a)-120(c) may be highly correlated and may be grouped to form a user group of the application server 110(c). The probing information may comprise available resources such as, for example, storage, testing equipment and/or measuring instruments, among the client devices 120(a)-120(c) in the user group. The application server 110(c) may be operable to share the available resources among the client devices 120(a)-120(c).

The application server 110(c) may process and aggregate the locally or remotely collected data from the client devices 120(a)-120(c). For medical applications, the locally collected data is patient data. In this regard, the application server 110(c) may be operable to perform multiple diagnostics and analysis of trends over the client devices 120(a)-120(c) in the user group utilizing the aggregated data and associated environmental conditions such as types of medical tests, reasons for ordering medical tests, specific medications, diagnoses, the way a clinician interprets the patient data, and geographic locations where the medical tests are performed. Possible causes and/or possible solutions may be identified based on the diagnostics and analysis of trends over the client devices 120(a)-120(c) in the user group. The possible causes and/or possible solutions together with associated environmental conditions may be communicated to the client devices 120(a)-120(c) as part of probing information. In this regard, the probing information may provide an indication of specific sensor behavior to the corresponding client devices 120(a)-120(c) in the user group, which may be utilized for early detection and prediction of disease outbreak. The associated sensors of the client device 120(a) and one or more other client devices in the user group may be deactivated or activated based on the specific sensor behavior. The activated sensors may be utilized by the client device 120(a) and/or other client devices in the user group to perform probing for remote patient monitoring. Users of the client device 120(a) may assess the probing information during the probing and may communicate the resulting user assessments to the application server 110(c) to build the data storage 110(a) on the computing cloud 110.

For electronic or electrical applications, the locally collected data may comprise measurement values of electrical resistance, electric current, electrical voltage, power levels, battery conditions, and low leakage levels. In this regard, the application server 110(c) may be operable to perform numerical analysis for trend estimate over the client devices 120(a)-120(c) in the user group utilizing the aggregated data and associated environmental conditions such as types of local tests, the way a local test is performed, temperature, air pressure, and moisture levels, and geographic locations where local tests are performed. Possible causes and/or possible solutions may be identified based on the analysis of trends over the client devices 120(a)-120(c) in the user group. The possible causes and/or possible solutions together with associated environmental conditions may be communicated to the client devices 120(a)-120(c) as part of probing information. In this regard, the probing information may provide an indication of specific sensor behavior to the corresponding client devices 120(a)-120(c) in the user group, which may be utilized for plan and perform local tests. The associated sensors of the client device 120(a) and one or more other client devices in the user group may be deactivated or activated based on the specific sensor behavior. The activated sensors may be utilized by the client device 120(a) and/or other client devices in the user group to perform probing for remote local testing. Users of the client device 120(a) may assess the probing information during the probing and may communicate the resulting user assessments to the application server 110(c) to build the data storage 110(a) on the computing cloud 110.

In an exemplary embodiment of the invention, data traffic between the remote instruments 132(a)-132(d) and the computing cloud 110 and/or the client devices 120 may be categorized or managed based on QoS and/or latency requirements corresponding to the data traffic. In this regard, the remote instruments 132(a)-132(d) may be operable to deploy or utilize RSA encryption devices for extra security. For example, a client device such as the client device 120(a) that attempts to access and utilize a remote instrument such as the remote instrument 132(a), may be asked to provide the matching RSA identification number to the RSA embedded device in the remote instruments 132(a)-132(d).

In some instances, the data processing or data collection at the remote instruments 132(a)-132(d) may be tagged or combined as a function of time, for example, with corresponding measurement conditions that comprise position, orientation, temperature, pressure, etc. as measured by the sensors 130(a)-130(d) available at the remote instruments 132(a)-132(d). The combined data may then be transported or communicated to the application servers 110(c)-110(d) in the computing cloud 110 and/or other client devices 120(b)-120(c).

In some instances, the remote instruments 132(a)-132(d) may comprise a positioning system and/or orientation/accelerometer capabilities to report its position/orientation/speed data or the history of such data over time to the computing cloud 110 and/or the client devices 120. In this regard, the computing cloud 110 may utilize the location data of the remote instruments 132(a)-132(d) to signal or instruct the client devices 120(a)-120(c) to configure or restrict task/job assignments to the corresponding remote instruments 132(a)-132(d) based on their corresponding geographical locations.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for server-assisted remote probing and data collection in a cloud computing environment.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a client device that is operable to communicate with a computing cloud, wherein said computing cloud comprises data storage and an application server:
receiving probing information from said application server, wherein said probing information is generated by said application server based on sensor data collected by one or more programmable sensors at a plurality of local and/or remote data collection sites; and
managing said one or more programmable sensors, wherein said managing comprises configuring said one or more programmable sensors to handle one or more local or remotely assigned tasks based on said received probing information and based on data traffic handled by said one or more sensors.

2. The method according to claim 1, wherein:
said sensor data is collected by one or more other sensors, which are managed by one or more other client devices that are served by said application server; and
said one or more other client devices are correlated with said client device.

3. The method according to claim 2, wherein said probing information comprises available resources among said client device and said one or more other client devices.

4. The method according to claim 3, wherein said available resources are shared among said client device and/or said one or more other client devices.

5. The method according to claim 2, wherein said probing information comprises specific sensor behavior for said sensors that are managed by said client device and/or specific sensor behavior for said one or more other sensors that are managed by said one or more other client devices.

6. The method according to claim 5, comprising, based on said specific sensor behavior for remotely probing, activating or deactivating:
said one or more of said programmable sensors that are managed by said client device; and/or
said one or more other sensors that are managed by said one or more other client devices.

7. The method according to claim 1, comprising managing data traffic between said one or more programmable sensors and said application server, and/or between said one or more programmable sensors and said one or more other client devices based on corresponding QoS requirements for said data traffic.

8. The method according to claim 7, comprising utilizing RSA encryption for said data traffic.

9. The method according to claim 1, comprising tagging said sensor data with corresponding measurement conditions as a function of time; and communicating said tagged sensor data to said application server.

10. The method according to claim 1, comprising configuring said one or more programmable sensors based on corresponding locations where said one or more programmable sensors perform collection of said sensor data.

11. A system for communication, the system comprising:
a client device that is operable to communicate with a computing cloud, wherein said computing cloud comprises a data storage and an application server, said client device being operable to:
receive probing information from said application server, wherein said probing information is generated by said application server based on sensor data collected by one or more programmable sensors at a plurality of local and/or remote data collection sites; and
managing said one or more programmable sensors, wherein said managing comprises configuring said one or more programmable sensors to handle one or more local or remotely assigned tasks based on said received probing information and based on data traffic handled by said one or more programmable sensors.

12. The system according to claim 11, wherein said sensor data is collected by said one or more programmable sensors, which are managed by one or more other client devices that are served by said application server; and said one or more other client devices are correlated with said client device.

13. The system according to claim 12, wherein said probing information comprises available resources among said client device and said one or more other client devices.

14. The system according to claim 13, wherein said available resources are shared among said client device and/or said one or more other client devices.

15. The system according to claim 12, wherein said probing information comprises specific sensor behavior for said sensors that are managed by said client device and/or specific sensor behavior for said one or more other sensors that are managed by said one or more other client devices.

16. The system according to claim 15, wherein, based on said specific sensor behavior for remotely probing, said client device is operable to activate or deactivate:
said one or more of said programmable sensors that are managed by said client device; and/or
said one or more other sensors that are managed by said one or more other client devices.

17. The system according to claim 11, wherein said client device is operable to manage data traffic between said one or more other sensors and said application server, and/or between said one or more other sensors and said one or more other client devices based on corresponding QoS requirements for said data traffic.

18. The system according to claim 17, wherein said client device is operable to utilize RSA encryption for said data traffic.

19. The system according to claim 11, wherein said client device is operable to tag said sensor data with corresponding measurement conditions as a function of time; and communicating said tagged sensor data to said application server.

20. The system according to claim 11, wherein said client device is operable to configure said one or more programmable sensors based on corresponding locations where said one or more programmable sensors perform collection of said sensor data.
